(19) United States
(12) Patent Application Publication
(10) Pub. No.: US 2009/0138510 A1
(43) Pub. Date: May 28, 2009

(54) METHOD AND APPARATUS FOR ASSOCIATING HELP DESK TICKET WITH AFFECTED DATA PROCESSING SYSTEM

(76) Inventors: Rhonda L. Childress, Austin, TX (US); David Bruce Kumhyr, Austin, TX (US); Stephen James Watt, Cedar Park, TX (US)

Correspondence Address: IBM CORP (YA);C/O YEE & ASSOCIATES PC, P.O. BOX 802333, DALLAS, TX, 75380, US

(21) Appl. No.: 11/946,717

(22) Filed: Nov. 28, 2007

(51) Int. Cl. G06F 17/30

(52) U.S. Cl. 707/104.1; 707/E17.009; 707/E17.134

(57) ABSTRACT

Computer implemented method, system and computer usable program code for servicing a problem with respect to a data processing system. A report of a problem with respect to a particular data processing system is received at a service facility. A help desk ticket is created for the received report that includes a description of the problem with respect to the particular data processing system. A ticket identifier is associated with the help desk ticket. The help desk ticket and the associated ticket identifier are stored in a database managed by the service facility, and the ticket identifier is also stored at the particular data processing system. The ticket identifier stored at the particular data processing system is accessed to identify the help desk ticket associated with the ticket identifier, and the help desk ticket identifies the problem with respect to the particular data processing system to enable servicing of the problem.

### CROSS-REFERENCE TO RELATED APPLICATIONS

The present application is related to the following applications entitled “METHOD AND APPARATUS FOR EXPOSING INFORMATION TECHNOLOGY SERVICE MANAGEMENT PROBLEMS TO A SYSTEMS MANAGEMENT SYSTEM”, Ser. No.______ attorney docket no. AUS920060699US1; and “METHOD AND APPARATUS FOR GENERATING STATISTICS ON INFORMATION TECHNOLOGY SERVICE MANAGEMENT PROBLEMS AMONG ASSETS”, Ser. No. ______, attorney docket no. AUS920070021US1.

### BACKGROUND OF THE INVENTION

1. Field of the Invention

The present invention relates generally to the data processing field and, more particularly, to a computer implemented method, system and computer usable program code for associating a problem with a data processing system that has been reported to a service facility with the data processing system to facilitate servicing of problems associated with the data processing system.

2. Description of the Related Art

Many organizations provide a service facility, often referred to as a “help desk”, to answer questions and correct problems relating to the use of PCs, servers or other data processing systems within the organization. When a data processing system within the organization encounters a problem, it is common practice for a user, owner or other individual associated with the affected system to report the problem to the help desk and request assistance. Upon receiving the problem report, the help desk typically creates a “ticket”, generally referred to herein as a “help desk ticket” that identifies the individual reporting the problem and the data processing system affected by the problem. The help desk ticket also includes a description of the problem. At an appropriate time, a service person, referencing the help desk ticket, will correct the reported problem, either directly from the help desk, if possible, or by traveling to the location of the affected data processing system.

Typically, a help desk ticket references a problem in a data processing system to the individual that reported the problem, for example, a first user of the data processing system. Accordingly, when the service person endeavors to correct the problem described in the help desk ticket, for example, by traveling to the location of the affected data processing system, the service person will have no knowledge of other problems that might affect the same data processing system, but that were reported to the help desk by other individuals, such as other users of the affected system. As a result, the service person will correct only the problem reported by the first individual, and may have to make subsequent trips to the location to correct the problems reported by the other individuals. This is an inefficient procedure for servicing data processing systems and can result in significant delays in correcting reported problems.

For similar reasons, the service person, when attending to correcting a problem with a data processing system at a particular location in response to a particular help desk ticket, will have no knowledge regarding problems that may have been reported with respect to other data processing systems at the same location and that could conveniently be attended to while the service person was already present at the location.

There is, accordingly, a need for a mechanism for associating a problem with a data processing system that has been reported to a service facility with the data processing system to facilitate servicing of problems associated with the data processing system.

### SUMMARY OF THE INVENTION

Exemplary embodiments provide a computer implemented method, system and computer usable program code for servicing a problem with respect to a data processing system. A report of a problem with respect to a particular data processing system is received at a service facility. A help desk ticket is created for the received report, wherein the help desk ticket includes a description of the problem with respect to the particular data processing system. A ticket identifier is associated with the help desk ticket. The help desk ticket and the associated ticket identifier are stored in a database managed by the service facility, and the ticket identifier is also stored at the particular data processing system. The ticket identifier stored at the particular data processing system is accessed, wherein the accessed ticket identifier identifies the help desk ticket associated with the ticket identifier stored in the database, and the help desk ticket identifies the problem with respect to the particular data processing system to enable servicing of the problem.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 is a pictorial representation of a network of data processing systems in which exemplary embodiments may be implemented;

FIG. 2 is a block diagram of a data processing system in which exemplary embodiments may be implemented;

FIG. 3 is a block diagram that illustrates a system for servicing a data processing system according to an exemplary embodiment; and

FIG. 4 is a flowchart that illustrates a method for servicing a data processing system according to an exemplary embodiment.

### DETAILED DESCRIPTION OF THE PREFERRED EMBODIMENT

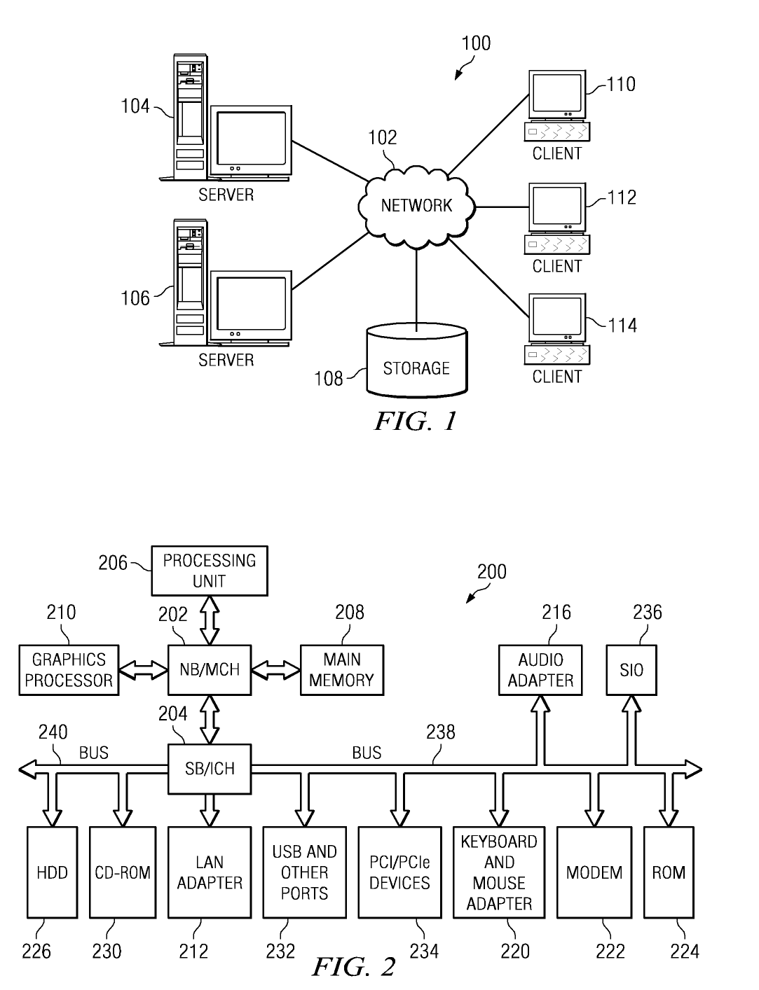

With reference now to the figures and in particular with reference to FIGS. 1-2, exemplary diagrams of data processing environments are provided in which exemplary embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which exemplary embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different exemplary embodiments.

With reference now to FIG. 2, a block diagram of a data processing system is shown in which exemplary embodiments may be implemented. Data processing system 200 is an example of a computer, such as server 104 or client 110 in FIG. 1, in which computer usable program code or instructions implementing the processes may be located for the exemplary embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the exemplary embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Many organizations provide a “help desk” to answer questions and correct problems relating to the use of PCs, servers or other data processing systems within the organization. When a data processing system within the organization encounters a problem, it is common practice for a user, owner or other individual associated with the affected system to report the problem to the help desk and request assistance. Upon receiving the problem report, the help desk typically creates a “ticket”, generally referred to herein as a “help desk ticket” that identifies the individual reporting the problem and the data processing system affected by the problem, and that includes a description of the problem. At an appropriate time, a service person, referencing the help desk ticket, will attend to correcting the reported problem, either directly from the help desk, if possible, or often, by traveling to the location of the affected system.

Typically, a help desk ticket references a problem in a data processing system to the individual that reported the problem, for example, a first user of the data processing system. Accordingly, when the service person endeavors to correct the problem described in the help desk ticket, for example, by traveling to the location of the affected data processing system, the service person will have no knowledge of other problems that might affect the same data processing system, but that were reported to the help desk by other individuals, such as other users of the system. As a result, the service person will correct only the problem reported by the first individual, and may have to make subsequent trips to the location to correct the problems reported by the other individuals. This is an inefficient procedure for servicing data processing systems and can cause significant delays in correcting reported problems.

Exemplary embodiments provide a computer implemented method, system and computer usable program code that facilitates servicing of problems with respect to data processing systems by associating a problem in a data processing system that has been reported to a help desk with the data processing system.

In accordance with an exemplary embodiment, when a problem with respect to a particular data processing system is received at a service facility, a help desk ticket is created for the received report that includes a description of the problem with respect to the particular data processing system. A ticket identifier is associated with the help desk ticket. The help desk ticket and the associated ticket identifier are stored in a database managed by the service facility, and the ticket identifier is also stored at the particular data processing system. The ticket identifier stored at the particular data processing system is accessed, wherein the accessed ticket identifier identifies the help desk ticket associated with the ticket identifier stored in the database, and the help desk ticket identifies the problem with respect to the particular data processing system to enable servicing of the problem.

Because ticket identifiers for all help desk tickets created for problems reported with respect to a data processing system are stored at the data processing system, a service person can access the ticket identifiers to identify all the problems so that they may be corrected in an efficient manner.

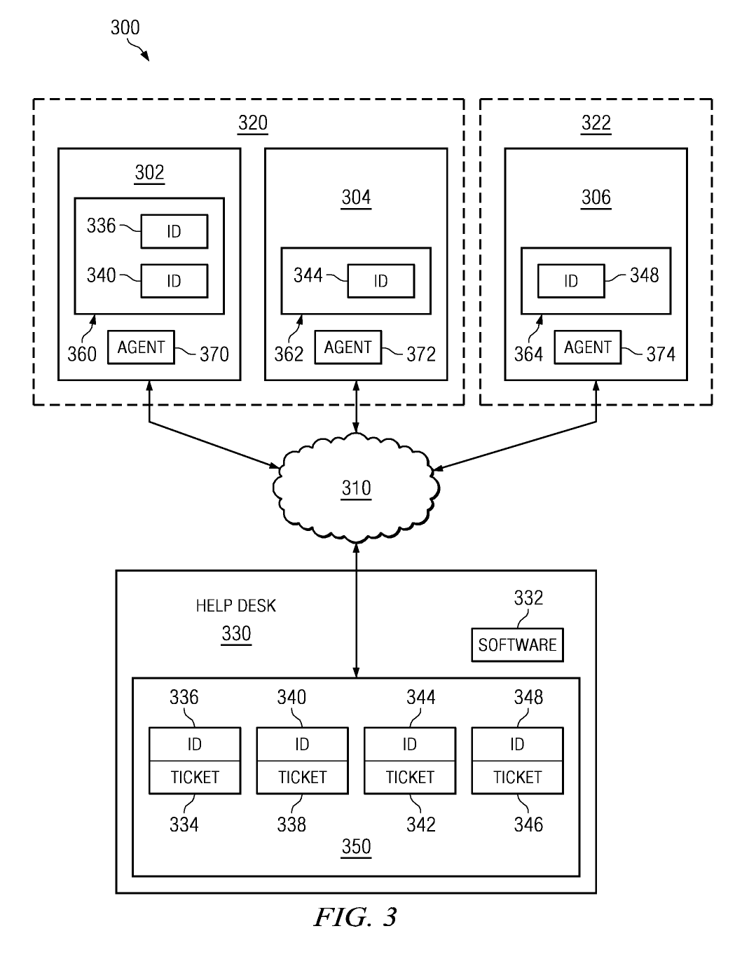

FIG. 3 is a block diagram that illustrates a system for servicing a data processing system according to an exemplary embodiment. The system is generally designated by reference number 300, and includes a plurality of data processing systems 302, 304 and 306. Each of data processing systems 302, 304 and 306 may be implemented as one of clients 110, 112, and 114, or one of servers 104 and 106 in FIG. 1, or as data processing system 200 in FIG. 2. Although three data processing systems are illustrated in FIG. 3, it should be understood that this is intended to be exemplary only. System 300 may include any number of data processing systems.

Data processing systems 302, 304 and 306 are connected to one another via network 310 which may be implemented as network 102 in FIG. 1. In this regard, it should be understood that systems 302, 304 and 306 may be physically located at the same general location, for example, in the same building or they may be at different locations spread over a large distance. In the exemplary embodiment illustrated in FIG. 3, data processing systems 302 and 304 are schematically shown as being at the same location 320, while data processing system 306 is schematically shown as being at a different location 322.

System 300 also includes help desk 330. Help desk 330 comprises a service facility that is provided by an organization, for example, a company or educational institution, to answer user questions and to solve problems encountered by users of data processing systems within the organization. Help desk 330 may be a department or individual within an organization, or it may be a third party service facility.

When a user or other individual encounters a particular problem with respect to a particular data processing system, for example, one of data processing systems 302, 304 or 306, the individual will typically report the problem to help desk 330. The reporting may be performed by, but not limited to, phone, email, fax, in person, etc. Help desk 330 will, at the appropriate time, attend to correct the problem. In some instances, the problem can be corrected from the help desk utilizing suitable help desk software 332. Frequently, however, it will be necessary to send a service person to the location of the affected system to make necessary repairs or the like to correct the problem.

In accordance with an exemplary embodiment, when help desk 330 receives a report of a problem from an individual with respect to a data processing system, such as data processing system 302 in FIG. 3, help desk 330 creates a help desk ticket, for example, help desk ticket 334 in FIG. 3 that identifies the individual reporting the problem and the data processing system affected by the problem, and that includes a description of the problem. In addition, a unique ticket identifier, for example, a ticket number, is assigned to the help desk ticket. As shown in FIG. 3, help desk ticket 334 has been assigned ticket identifier 336.

Help desk ticket 334, together with its ticket identifier 336, is then stored in database 350 at or otherwise managed by the help desk.

Each time a problem with respect to a data processing system is reported to help desk 330, a similar procedure is followed such that help desk 330 may, over a period of time, create and store help desk tickets identifying a number of problems that have been reported for different data processing systems throughout the organization. Thus, FIG. 3 also illustrates a plurality of other help desk tickets 338, 342 and 346 stored in database 350, each having their own unique ticket identifier 340, 344 and 348, respectively.

As indicated previously, a help desk ticket typically references a problem in a data processing system to the individual that reported the problem. Accordingly, when a service person endeavors to correct the problem identified by a particular help desk ticket, the service person will have no knowledge of other problems that might affect the same data processing system, but that were reported to the help desk by other individuals. As a result, the service person will repair or otherwise correct only the problem described in the particular help desk ticket, and may have to make subsequent trips to the location of the affected data processing system to correct the problems reported by the other individuals and described in other help desk tickets. This is an inefficient procedure for servicing data processing systems and can cause significant delays in correcting reported problems.

In accordance with an exemplary embodiment, these inefficiencies are addressed by storing the ticket identifiers assigned to and associated with each help desk ticket at the data processing systems that have the problems described in the help desk tickets. Specifically, as shown in FIG. 3, ticket identifier 336 assigned to help desk ticket 334 describing a problem reported with respect to data processing system 302, is transmitted from help desk 330 to data processing system 302, and is stored in data storage unit 360 of data processing system 302. Data storage unit 360 may, for example, be the system hard drive, a RAM on an interface card, or another suitable storage medium.

Because ticket identifier 336 is stored at data processing system 302, data processing system 302 is made aware of and thus “knows” that a problem has been reported to the help desk with respect to the system. As a result, data processing system 302 itself is able to advise a service person or another individual of the problem.

According to an exemplary embodiment, each of data processing systems 302, 304 and 306 includes an agent 370, 372 and 374, respectively, which may be added to the systems or a modification may be made to existing agents on the systems. Agents 370, 372 and 374 are able to beacon help ticket identifiers stored in their respective data processing system to a service person or another individual. The agents may beacon the information in response to a specific request to do so, or they may do so at a predetermined interval. Either way, a service person is able to ascertain if any problems have been reported regarding any of the data processing systems, and, if so, is able to identify the appropriate help desk tickets from the ticket identifiers so as to be able to identify and attend to the reported problems.

According to exemplary embodiments, therefore, all problems in connection with data processing systems that have been reported to the help desk are associated directly with the data processing systems having the problems such that a service person is able to identify all the problems to facilitate servicing of the data processing systems.

Consider, for example, a situation in which a service person is assigned to correct a particular problem reported with respect to data processing system 302 in FIG. 3 and described in help desk ticket 334. The service person travels to location 320 of system 302 and corrects the problem. In accordance with an exemplary embodiment, the service person can query system 302 to determine if any other problems have been reported with respect to system 302. In the exemplary embodiment illustrated in FIG. 3, a second problem has, in fact, been reported, a help desk ticket 338 with ticket identifier 340 had been created and stored at help desk 330, and the ticket identifier 340 has been transmitted to and stored at system 302. The service person is thus able to identify help desk ticket 338, identify the other problem and correct the other problem while at location 320. Thus, the service person may attend to all problems that have been reported with respect to data processing system 302 during the same visit to location 320, eliminating the need for subsequent trips.

In a similar manner, while the service person is at location 320, he can also query other data processing systems at that location to see if problems have been reported with respect to the other systems. In FIG. 3, help desk ticket 342 having ticket identifier 344 has been created and the ticket identifier stored at system 304 so that the service person can be apprised of and attend to the problem with that system during the same visit to location 320.

It may also occur that location 322 in FIG. 3 is “on the way” to location 320. The service person could stop at location 322 on his way back from location 320 and check out data processing system 306 at that location, determine that help desk ticket 346 with identifier 348 has been created and attend to correcting the problem with respect to that system as well.

In general, because reported problems are associated directly with data processing systems having the problems, exemplary embodiments allow all reported problems with respect to any particular data processing system to be easily identified so that the problems can be attended to in an efficient manner.

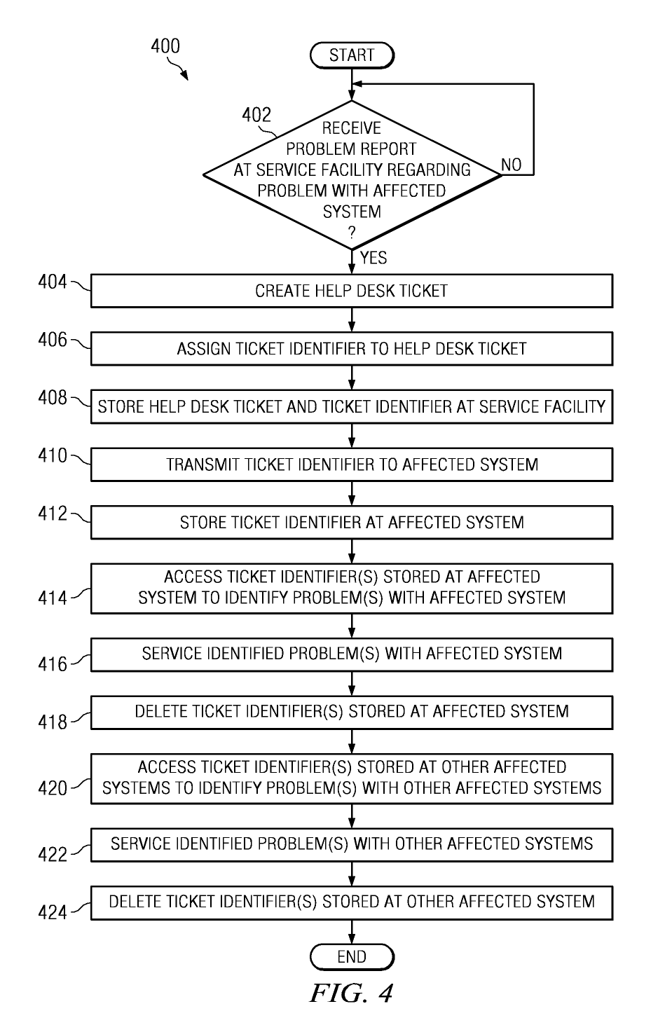

FIG. 4 is a flowchart that illustrates a method for servicing a data processing system according to an exemplary embodiment. The method is generally designated by reference number 400, and begins by a service facility waiting to receive a report of a particular problem regarding a particular data processing system (Step 402). The service facility may be a help desk of a company or other organization, or any other entity that provides assistance with respect to repairing or otherwise correcting problems associated with data processing systems of the organization. The report may be sent by a user or owner of the particular data processing system, or by another individual, and may be sent by phone, email, fax, in person or in any other appropriate manner.

When it is determined that a report of a problem has been received (Yes output of Step 402), a help desk ticket is created for the problem (Step 404). The help desk ticket may include the identity of the individual that reported the problem and the identity of the particular data processing system affected by the problem, as well as a description of the reported problem.

A ticket identifier, for example, an identification number, that uniquely identifies the help desk ticket is assigned to the created help desk ticket (Step 406), and the help desk ticket and its associated ticket identifier are then stored in a database at or otherwise managed by the service facility (Step 408).

At least the ticket identifier is also transmitted to the particular data processing system having the problem described in the help desk ticket (Step 410), and is stored at the particular data processing system (Step 412). Thus, the particular data processing system is made aware of and “knows” that a problem has been reported; and, in addition, the problem can be identified because it knows the ticket identifier assigned to the help desk ticket describing the problem.

A service person or another individual can then access the stored ticket identifier to identify the problem (Step 414) and attend to the identified problem in the appropriate manner (Step 416).

Returning to Step 402, the service facility continues to monitor for problem reports as indicated by the No output of Step 402 and creates help desk tickets with ticket identifiers for all problems reported to it. Thus, the service facility may, over time, create and store a plurality of help desk tickets, each having its own ticket identifier and each relating to a particular reported problem associated with any of the data processing systems of the organization. At the same time, each data processing system of the organization will receive and store one or more ticket identifiers identifying the one or more reported problems that are specifically associated with the respective data processing system. Thus, in Step 414, a service person may identify all reported problems with an affected system and attend to correct all the problems in Step 416.

When a problem has been corrected in Step 416, the ticket identifier for that problem may be deleted from the data storage unit of the data processing system (Step 418).

A service person may also query other data processing systems to identify reported problems with respect to the other data processing systems (Step 420). For example, the service person could check other data processing systems at the same location of a data processing system that has already been attended to. The service person can then attend to correcting the identified problems with the other data processing systems (Step 422), and once corrected, delete the ticket identifiers from the other data processing systems (Step 424).

It should be understood that the exemplary embodiment illustrated in FIG. 4 can be varied in numerous ways. For example, the order of performing various of the steps can be varied as desired. For example, a service person might query and identify reported problems with all data processing systems at a particular location upon arriving at the location. Alternatively, the service person could correct one particular problem with one data processing system at a location and then check to see if there are other problems with respect to the same or different systems at the location after correcting the particular problem.

Exemplary embodiments thus provide a computer implemented method, system and computer usable program code for servicing a problem with respect to a data processing system. A report of a problem with respect to a particular data processing system is received at a service facility. A help desk ticket is created for the received report, wherein the help desk ticket includes a description of the problem with respect to the particular data processing system. A ticket identifier is associated with the help desk ticket. The help desk ticket and the associated ticket identifier are stored in a database managed by the service facility, and the ticket identifier is also stored at the particular data processing system. The ticket identifier stored at the particular data processing system is accessed, wherein the accessed ticket identifier identifies the help desk ticket associated with the ticket identifier stored in the database, and the help desk ticket identifies the problem with respect to the particular data processing system to enable servicing of the problem.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for servicing a problem with respect to a data processing system, the computer implemented method comprising:
receiving, at a service facility, a report of a problem with respect to a particular data processing system;
creating a help desk ticket for the received report, wherein the help desk ticket includes a description of the problem with respect to the particular data processing system;
associating a ticket identifier with the help desk ticket;
storing the help desk ticket and the associated ticket identifier in a database managed by the service facility;
storing the ticket identifier at the particular data processing system; and
accessing the ticket identifier stored at the particular data processing system, wherein the accessed ticket identifier identifies the help desk ticket associated with the ticket identifier stored in the database, and the help desk ticket identifies the problem with respect to the particular data processing system to enable servicing of the problem.

2. The computer implemented method according to claim 1, further comprising:
receiving, at the service facility, another report of another problem with respect to the particular data processing system;
creating another help desk ticket for the another received report, wherein the another help desk ticket for the another received report includes an associated another ticket identifier;
storing the another ticket identifier for the another help desk ticket at the particular data processing system; and
accessing the another ticket identifier stored at the particular data processing system to identify the another problem reported with respect to the particular data processing system.

3. The computer implemented method according to claim 1, further comprising:
receiving, at the service facility, a further report of a further problem with respect to a different data processing system;
creating a further help desk ticket for the further report, wherein the further help desk ticket includes an associated further ticket identifier;
storing the further ticket identifier at the different data processing system; and
accessing the further ticket identifier stored at the different data processing system to identify the further problem reported with respect to the different data processing system.

4. The computer implemented method according to claim 1, wherein accessing the ticket identifier stored at the particular data processing system from the particular data processing system, comprises:
receiving a beacon of the ticket identifier sent by the particular data processing system.

5. The computer implemented method according to claim 4, wherein receiving a beacon of the ticket identifier sent by the particular data processing system, comprises one of receiving the beacon sent upon request or receiving the beacon sent at a predetermined interval.

6. The computer implemented method according to claim 1, and further comprising:
deleting the stored ticket identifier from the data processing system after the problem has been serviced.

7. The computer implemented method according to claim 1, wherein the ticket identifier comprises a ticket number.

8. A computer program product, comprising:
a computer usable medium having computer usable program code for servicing a problem with respect to a data processing system, the computer program product comprising:
responsive to receiving a report of a problem with respect to a particular data processing system at a service facility, computer usable program code configured for creating a help desk ticket for the received report, wherein the help desk ticket includes a description of the problem with respect to the particular data processing system;
computer usable program code configured for associating a ticket identifier with the help desk ticket;
computer usable program code configured for storing the help desk ticket and the associated ticket identifier in a database managed by the service facility;
computer usable program code configured for storing the ticket identifier at the particular data processing system; and
computer usable program code configured for accessing the ticket identifier stored at the particular data processing system, wherein the accessed ticket identifier identifies the help desk ticket associated with the ticket identifier stored in the database, and the help desk ticket identifies the problem with respect to the particular data processing system to enable servicing of the problem.

9. The computer program product according to claim 8, further comprising:
responsive to receiving, at the service facility, another report of another problem with respect to the particular data processing system, computer usable program code configured for creating another help desk ticket for the another received report, wherein the another help desk ticket for the another received report includes an associated another ticket identifier;
computer usable program code configured for storing the another ticket identifier for the another help desk ticket at the particular data processing system; and
computer usable program code configured for accessing the another ticket identifier stored at the particular data processing system to identify the another problem reported with respect to the particular data processing system.

10. The computer program product according to claim 8, further comprising:
responsive to receiving, at the service facility, a further report of a further problem with respect to a different data processing system, computer usable program code configured for creating a further help desk ticket for the further report, wherein the further help desk ticket includes an associated further ticket identifier;
computer usable program code configured for storing the further ticket identifier at the different data processing system; and
computer usable program code configured for accessing the further ticket identifier stored at the different data processing system to identify the further problem reported with respect to the different data processing system.

11. The computer program product according to claim 8, and further comprising:
computer usable program code configured for deleting the stored ticket identifier from the data processing system after the problem has been serviced.

12. A system for servicing a problem with respect to a data processing system, comprising:
a help desk ticket, the help desk ticket including a description of a problem reported to a service facility with respect to a particular data processing system;
a ticket identifier associated with the help desk ticket;
a database managed by the service facility for storing the help desk ticket and the associated ticket identifier;
a storage unit for storing the ticket identifier at the particular data processing system; and
an accessing mechanism for accessing the ticket identifier stored at the particular data processing system, wherein the accessed ticket identifier identifies the help desk ticket associated with the ticket identifier stored in the database, and the help desk ticket identifies the problem with respect to the particular data processing system to enable servicing of the problem.
